(19) United States
(12) Patent Application Publication
(10) Pub. No.: US 2009/0284181 A1
(43) Pub. Date: Nov. 19, 2009

(54) BACKLIGHT UNIT ASSEMBLY, DISPLAY DEVICE HAVING THE SAME, AND METHOD OF DIMMING THE DISPLAY DEVICE

(76) Inventors: Hyuk-Hwan Kim, Asan-si (KR); Hyun-Jin Kim, Yongin-si (KR); Chi-O Cho, Asan-si (KR); Seok-Hyun Nam, Seoul (KR)

Correspondence Address: F. CHAU & ASSOCIATES, LLC, 130 WOODBURY ROAD, WOODBURY, NY, 11797, US

(21) Appl. No.: 12/335,929

(22) Filed: Dec. 16, 2008

(30) Foreign Application Priority Data
May 19, 2008 (KR) 10-2008-0046195

(51) Int. Cl. H05B 37/02

(52) U.S. Cl. 315/307

(57) ABSTRACT

A backlight unit assembly includes a surface light source with a plurality of first electrode lines extending in a first direction, a plurality of second electrode lines and a plurality of discharge blocks defined in regions where the first and second electrode lines cross each other, respectively; a memory stores discharge/non-discharge data; a luminance calculator calculates luminances of a selected region based on an image signal; and a dimming controller outputs dimming control signals corresponding to the calculated luminances by using the discharge/non-discharge data stored in the memory. A first driving signal is transmitted to one of the first electrode lines, a second driving signal having a different waveform from the first driving signal is transmitted to another of the first electrode lines adjacent the above first electrode line, and a driving voltage is applied to one of the second electrodes lines that crosses the above two first electrode lines.

This application claims priority from Korean Patent Application No. 10-2008-0046195 filed on May 19, 2008 in the Korean Intellectual Property Office, the disclosure of which is incorporated herein by reference in its entirety.

### BACKGROUND OF THE INVENTION

1. Technical Field

The present disclosure relates to a backlight unit assembly, a display device having the same, and a method of dimming the display device and, more particularly, to a backlight unit assembly that can simultaneously drive every two adjacent discharge blocks of a surface light source when the surface light source is locally dimmed, a display device having the backlight unit assembly, and a method of dimming the display device.

2. Discussion of Related Art

Flat panel displays (FPDs), such as liquid crystal displays (LCDs) and plasma display panels (PDPs), are being rapidly developed to replace cathode ray tubes (CRTs). Unlike PDPs, LCDs are not self light-emitting display devices. Thus, they require a light source. LCDs may include various forms of light sources according to their particular screen display method. For example, LCDs may include a backlight unit located behind the LCD panel.

As its light source, a backlight unit generally uses point light sources, such as light emitting diodes (LEDs), or line light sources, such as electroluminescent lamps (ELs) and cold cathode fluorescent lamps (CCFLs). When point light sources or line light sources are used, however, their light must be modified just like the light of a conventional surface light source, and a number of optical parts are required to modify the light.

In this regard, surface light sources, which can replace point light sources and line light sources, are being actively developed. A conventional surface light source includes upper and lower substrates, on which electrodes are respectively formed, and a discharge gas filled between the upper and lower substrates. In the conventional surface light source, an electric discharge occurs due to the voltage difference between the two electrodes of the upper and lower substrates.

Due to its superior discharge characteristics and stable driving voltage margin, mercury has been used as a discharge gas for conventional surface light sources. Because mercury is environmentally unsound, however, its use is limited. In addition, when the temperature of a lamp is low, it is difficult to drive the lamp, and the efficiency of the lamp deteriorates. For this reason, surface light sources that use a mercury-free discharge gas have been developed. Mercury-free surface light sources are completely flat fluorescent lamps filled with a mercury-free gas, such as xenon (Xe). Mercury-free surface light sources have a simple structure and operate independently of temperature. In addition, they can be easily manufactured and can have increased sizes. Therefore, mercury-free surface light sources are drawing a lot of attention for use as light sources in display devices.

Referring again to LCDs, local dimming is being applied to enhance the image quality of LCDs and to reduce the power consumption thereof. Local dimming refers to actively driving a backlight unit based on image information. Currently, local dimming is being applied to backlight units that use LEDs as their light source, but not to backlight units that use CCFLs, due to the linear morphological characteristics of the CCFLs. Local dimming can be applied to mercury-free surface light sources, however, because they are completely flat light-emitting sources. Accordingly, various attempts are being made to apply local dimming to mercury-free surface light sources.

In practicing local dimming, a mercury-free surface light source is divided into a matrix of m×n discharge blocks. When a mercury-free surface light source includes m×n discharge blocks, a number of drivers equal to the number of discharge blocks, that is, m×n drivers, are required. Recently, a mercury-free surface light source using a matrix driving method has been developed for local dimming. In the matrix driving method, a voltage output from each horizontal driver and a voltage output from each vertical driver are applied to a corresponding one of the m×n discharge blocks of a surface light source in directions that intersect each other, in order to drive the corresponding discharge block. Therefore, the number of drivers required can be reduced from m×n to m+n.

That is, in a mercury-free surface light source using the matrix driving method, an electric discharge occurs at each intersection of the upper and lower electrodes due to the potential difference between the upper and lower electrodes. For local dimming, discharge blocks in each row of a mercury-free surface light source are simultaneously driven and dimmed. That is, rows of the mercury-free surface light source are sequentially driven in a vertical direction, which is referred to as a scan-driving method.

For example, when a surface light source using the matrix driving method includes a column of five discharge blocks, it may be driven by the scan-driving method at a duty ratio of 20%. That is, during a frame, the five discharge blocks in the column are sequentially driven, each at a duty ratio of 20%. The 20% duty ratio, however, is only about half a duty ratio (40 to 50%) used when a CCFL backlight unit or a hot cathode fluorescent lamp (HCFL) backlight unit is driven by the scan-driving method. Therefore, in a backlight unit using scan-driving method, a surface light source provides a significantly lower luminance to a LCD panel in comparison with other types of light sources.

### SUMMARY OF THE INVENTION

Exemplary embodiments of the present invention provide a backlight unit assembly that can simultaneously drive every two adjacent discharge blocks of a surface light source and, thus, can prevent a reduction in the luminance of a display panel during scan-driving.

Exemplary embodiments of the present invention also provide a display device that can simultaneously drive every two adjacent discharge blocks of a surface light source and, thus, can prevent a reduction in the luminance of a display panel during scan-driving.

Exemplary embodiments of the present invention also provide a dimming method that can simultaneously drive every two adjacent discharge blocks of a surface light source and, thus, can prevent a reduction in the luminance of a display panel during scan-driving.

The exemplary embodiments, however, of the present invention are not restricted to the ones set forth herein. The above and other exemplary embodiments of the present invention will become more apparent to one of ordinary skill in the art to which the present invention pertains by referencing the detailed description given below.

According to an exemplary embodiment of the present invention, there is provided a backlight unit assembly including: a surface light source that includes a plurality of first electrode lines extending in a first direction, a plurality of second electrode lines insulated from the first electrode lines and extending in a second direction, and a plurality of discharge blocks defined in regions where the first and second electrode lines cross each other, respectively; a memory that stores discharge/non-discharge data; a luminance calculator that calculates luminances of a selected region based on an image signal; and a dimming controller that outputs dimming control signals corresponding to the calculated luminances by using the discharge/non-discharge data stored in the memory. A first driving signal is transmitted to any one of the first electrode lines, a second driving signal having a different waveform from the first driving signal is transmitted to another one of the first electrode lines that is adjacent the above-mentioned first electrode line, and a driving voltage is applied to one of the second electrodes lines that crosses the above-mentioned two first electrode lines. The first and second driving signals and the driving voltage are adjusted according to the dimming control signals and provided accordingly. The discharge/non-discharge data indicates whether each of two adjacent ones of the discharge blocks is discharged according to each combination of voltage levels of the first driving signal, the second driving signal, and the driving voltage that are provided to a region in which the two adjacent discharge blocks are defined.

According to an exemplary embodiment of the present invention, there is provided a display device including: a display panel that displays an image; a display panel driver that drives the display panel; a surface light source that includes a plurality of first electrode lines extending in a first direction, a plurality of second electrode lines insulated from the first electrode lines and extending in a second direction, and a plurality of discharge blocks defined in regions where the first and second electrode lines cross each other, respectively; a memory that stores discharge/non-discharge data; a luminance calculator that calculates luminances of a selected region based on an image signal; and a dimming controller that outputs dimming control signals corresponding to the calculated luminances by using the discharge/non-discharge data stored in the memory. A first driving signal is transmitted to any one of the first electrode lines, a second driving signal having a different waveform from the first driving signal is transmitted to another one of the first electrode lines that is adjacent the above-mentioned first electrode line, and a driving voltage is applied to one of the second electrodes lines that crosses the above-mentioned two first electrode lines. The first and second driving signals and the driving voltage are adjusted according to the dimming control signals and provided accordingly. The discharge/non-discharge data indicates whether each of two adjacent ones of the discharge blocks is discharged according to each combination of voltage levels of the first driving signal, the second driving signal, and the driving voltage that are provided to a region in which the two adjacent discharge blocks are defined.

According to another aspect of the present invention, there is provided a dimming method including: providing a display device having a surface light source that includes a plurality of first electrode lines extending in a first direction, a plurality of second electrode lines insulated from the first electrode lines and extending in a second direction, and a plurality of discharge blocks defined in regions where the first and second electrode lines cross each other, respectively; storing discharge/non-discharge data indicating whether each of two adjacent ones of the discharge blocks is discharged according to each combination of voltage levels of a first driving signal, a second driving signal, and a driving voltage that are provided to a region in which the two adjacent discharge blocks are defined; calculating luminances of display panel blocks based on an image signal; outputting dimming control signals corresponding to the calculated luminances by using the discharge/non-discharge data; and adjusting the first and second driving signals and the driving voltage according to the dimming control signals and providing the adjusted first and second driving signals and driving voltage, wherein the first driving signal is transmitted to any one of the first electrode lines, the second driving signal having a different waveform from the first driving signal is transmitted to another one of the first electrode lines which is adjacent to the above first electrode line, and the driving voltage is applied to one of the second electrodes lines which crosses the above two first electrode lines.

### BRIEF DESCRIPTION OF THE DRAWINGS

Exemplary embodiments of the present invention will be understood in more detail from the following descriptions taken in conjunction with the attached drawings, in which:

FIG. 1 is a schematic exploded perspective view of an LCD according to an exemplary embodiment of the present invention;

FIG. 2A is a schematic plan view of a surface light source shown in FIG. 1;

FIG. 2B is a cross-sectional view of the surface light source taken along the line I-I′ of FIG. 2A;

FIG. 3 is a configuration diagram for explaining a conversion unit and a backlight unit driver shown in FIG. 1;

FIG. 4A is a schematic diagram of a first switching unit and its surroundings according to an exemplary embodiment of the present invention;

FIG. 4B is a waveform diagram of control signals transmitted to control the waveform of a first driving signal;

FIG. 4C is a waveform diagram of control signals transmitted to control the waveform of a second driving signal;

FIG. 5 is a schematic configuration diagram of a second switching unit and its surroundings according to an exemplary embodiment of the present invention;

FIG. 6 is a flowchart illustrating a dimming method according to an exemplary embodiment of the present invention;

FIG. 7 are waveform diagrams of the first and second driving signals that are transmitted to respective first electrode lines of two adjacent discharge blocks according to an exemplary embodiment of the present invention;

FIG. 8 schematically illustrates basic combinations for simultaneously driving two adjacent discharge blocks;

FIG. 9 schematically illustrates the discharge or non-discharge state of each of two adjacent discharge blocks in each section;

FIGS. 10A and 10B schematically illustrate the proportion of each section, in which each of two adjacent discharge blocks is discharged or undischarged, in a frame; and

FIGS. 11A and 11B schematically illustrate the proportion of each section, in which each of two adjacent discharge blocks, which are horizontally adjacent two vertically adjacent discharge blocks, respectively, that is discharged or undischarged, in a frame.

### DETAILED DESCRIPTION OF EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those of ordinary skill in the art, and the present invention will only be defined by the appended claims. Like reference numerals refer to like elements throughout the specification. As used herein, the term “and/or” includes any and all combinations of one or more of the associated listed items.

Hereinafter, a backlight unit assembly, a display device employing the same, and a method of dimming the display device according to exemplary embodiments of the present invention will be described with reference to the attached drawings.

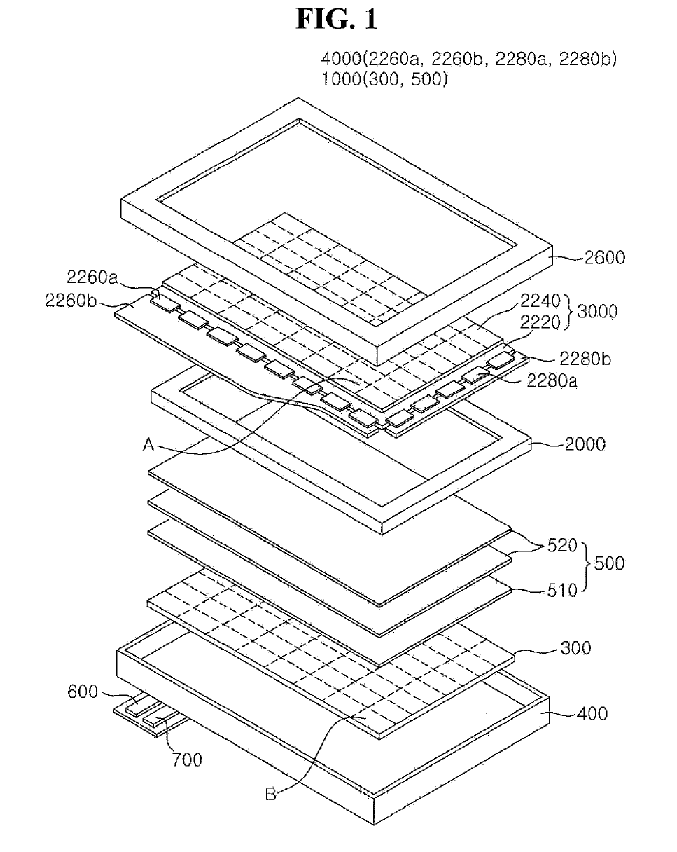

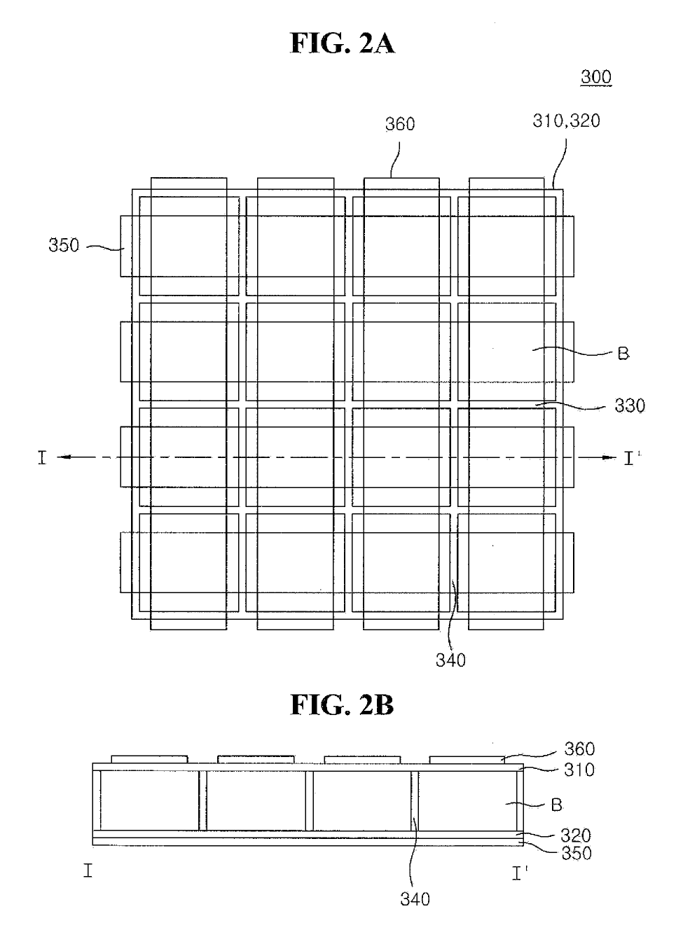

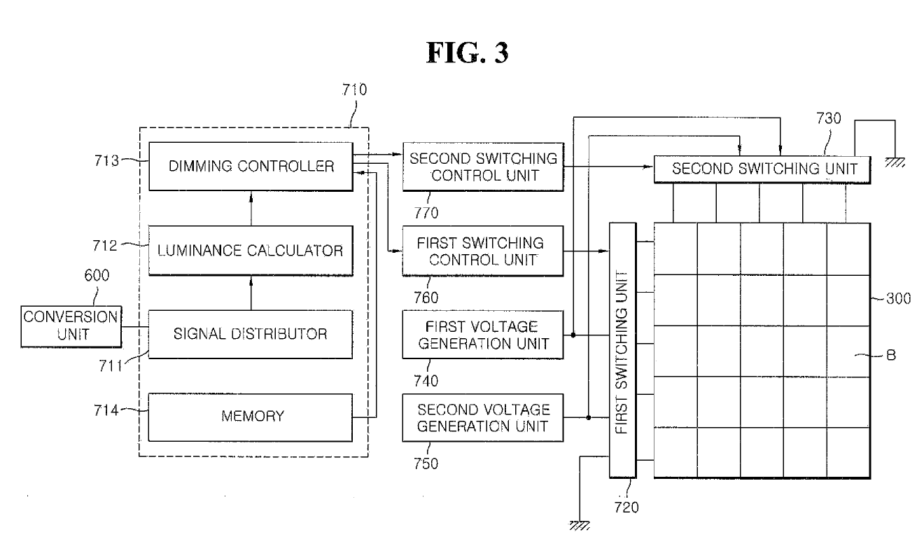

FIG. 1 is a schematic exploded perspective view of a liquid crystal display (LCD) according to an exemplary embodiment of the present invention. FIG. 2A is a schematic plan view of a surface light source 300 shown in FIG. 1. FIG. 2B is a cross-sectional view of the surface light source 300 taken along the line I-I′ of FIG. 2A. FIG. 3 is a configuration diagram for explaining a conversion unit 600 and a backlight unit driver 700 shown in FIG. 1.

Referring to FIG. 1, the LCD according to the exemplary embodiment includes a LCD panel assembly and a backlight unit assembly. The LCD panel assembly includes a LCD panel 3000 and a LCD panel driver 4000 that drives the LCD panel 3000. The backlight driver is not shown individually outside of its reference number 4000, and the reference numbers of the units that it drives are shown parenthetically. The backlight unit assembly includes a backlight unit 1000 that provides light to the LCD panel 3000 and the backlight unit driver 700 that drives the backlight unit 1000. The backlight unit is not shown individually except for its reference number 1000, and the units that make it up are shown parenthetically. The LCD may further include upper and lower housing members 2600 and 400 to accommodate and protect the LCD panel assembly and the backlight unit assembly, respectively.

The LCD panel 3000 may be divided into a plurality of LCD panel blocks A of a predetermined size. The LCD panel blocks A are virtual block regions that are defined by a predetermined number of data lines and a predetermined number of gate lines, respectively, and that are arranged in a matrix. The surface light source 300 of the backlight unit 1000 may also be divided into a plurality of discharge blocks B that correspond to the LCD panel blocks A, respectively.

The LCD panel assembly includes the LCD panel 3000 and the LCD panel driver 4000. The LCD panel 3000 includes a thin-film transistor (TFT) substrate 2220, a color filter substrate 2240 that faces the TFT substrate 2220, and a liquid crystal layer (not shown) that is interposed between the TFT substrate 2220 and the color filter substrate 2240. The LCD panel driver 4000 drives the LCD panel 3000, however, the electrical connections are not shown. The LCD panel 3000 may further include upper and lower polarizers (not shown) that are disposed on a top surface of the color filter substrate 2240 and a bottom surface of the TFT substrate 2220, respectively.

The TFT substrate 2220 includes, on a transparent glass substrate, the gate lines (not shown) that extend in one direction, for example, a horizontal direction, the data lines that extend in another direction, that is, a vertical direction, and TFTs (not shown) and pixel electrodes (not shown) that are formed in regions where the gate lines cross the data lines, respectively. Each of the TFTs includes a gate terminal, a source terminal and a drain terminal. The gate terminal is connected to a gate line, the source terminal is connected to a data line, and the drain terminal is connected to a pixel electrode. When electrical signals are transmitted to the gate lines and the data lines of the TFT substrate 2220, each of the TFTs is turned on or turned off. A signal required to form an image is transmitted to the drain terminal of each TFT. Consequently, an image is displayed.

The color filter substrate 2240 includes red (R), green (G) and blue (B) pixels on a transparent substrate. The R, G and B pixels are color pixels that show predetermined colors, respectively, when light passes therethrough. A common electrode is formed on the entire surface of the color filter substrate 2240. The common electrode is made of a transparent conductor, such as indium tin oxide (ITO) or indium zinc oxide (IZO), which is a transparent, conductive thin film.

The LCD panel driver 4000 includes a data tape carrier package (TCP) 2260a and a gate TCP 2280a, which are connected to the TFT substrate 2220, and a data printed circuit board (PCB) 2260b and a gate PCB 2280b, which are connected to the data TCP 2260a and the gate TCP 2280a, respectively, in order to drive the LCD panel 3000. For simplicity, the connections are not shown in FIG. 1.

The backlight unit assembly includes the backlight unit 1000 and the backlight unit driver 700 and provides light to the LCD panel 3000. The backlight unit 1000 includes the surface light source 300, which has the discharge blocks B, and optical sheets 500 that improve the quality of light emitted from the surface light source 300. The backlight unit 1000 may further include a mold frame 2000 to fix the surface light source 300 and the optical sheets 500.

Referring to FIGS. 2A and 2B, the surface light source 300 includes upper and lower substrates 310 and 320 that face each other, a plurality of first and second sidewalls 330 and 340 that are interposed between the upper and lower substrates 310 and 320 and that cross each other, the discharge blocks B that are defined by the first and second sidewalls 330 and 340, and a plurality of first and second electrode lines 350 and 360 that are formed on the lower and upper substrates 320 and 310, respectively.

Each of the upper and lower substrates 310 and 320 is made of a material such as glass or silica. The upper and lower substrates 310 and 320 are separated from each other by a predetermined gap, for example, 1 to 3 mm. The first sidewalls 330 are formed between the upper and lower substrates 310 and 320 and are arranged in one direction, for example, the horizontal direction, at predetermined intervals. The second sidewalls 340 are formed between the upper and lower substrates 310 and 320 and arranged in another direction, for example, the vertical direction, at predetermined intervals. The first and second sidewalls 330 and 340 are also formed at edges of the upper and lower substrates 310 and 320.

Each of the discharge blocks B is defined by two adjacent ones of the first sidewalls 330 and two adjacent ones of the second sidewalls 340. Thus, the number of the discharge blocks B is determined by the number of the first and second sidewalls 330 and 340. The discharge blocks B are filled with phosphors. For example, the discharge blocks B are filled with a mercury-free gas such as xenon (Xe). Alternatively, the discharge blocks B may be filled with a mixture of the Xe gas and an inert gas, such as helium (He), neon (Ne), argon (Ar) or krypton (Kr).

The first electrode lines 350 are formed on a bottom surface of the lower substrate 320 that does not face the upper substrate 310, are separated from each other by a predetermined gap, and extend in the horizontal direction. The first electrode lines 350 are separated from each other by a region that corresponds to each of the first sidewalls 330. The second electrode lines 360 are formed on a top surface of the upper substrate 310 that does not face the lower substrate 320, are separated from each other by a predetermined gap, and extend in the vertical direction. The second electrode lines 360 are separated from each other by a region that corresponds to each of the second sidewalls 340.

The first electrode lines 350 may be made of an opaque metal material to prevent light, which is emitted from the surface light source 300 by the electric discharge, from proceeding in a downward direction. Conversely, the second electrode lines 360 may be made of a transparent, conductive material, such as ITO or IZO, to allow light emitted from the surface light source 300 to proceed in an upward direction without loss. In addition, a reflective plate (not shown) may be formed on or under each of the first electrode lines 350 in order to reflect light from the surface light source 300 in the upward direction.

As shown in FIG. 1, the optical sheets 500 may include a diffusion sheet 510 and prism sheets 520 to improve the quality of light emitted from the surface light source 300 and the efficiency of light utilization. The diffusion sheet 510 is formed on a top surface of the surface light source 300 to uniformly diffuse light from the surface light source 300 and deliver the diffused light in the forward direction of the prism sheets 520 and the LCD panel 3000, thereby widening a viewing angle. The diffusion sheet 510 may be made of polycarbonate (PC) resin or polyester (PET) resin. The prism sheets 520 refract and concentrate light output from the diffusion sheet 510 to increase the luminance of the light and send the light with the increased luminance to the LCD panel 3000. The prism sheets 520 may include band-shaped micro prisms formed on a base material such as PET. One horizontal prism sheet and one vertical prism sheet may be used as a set of the prism sheets 520.

The backlight unit driver 700 shown in FIG. 1 supplies power to the discharge blocks B in a controlled manner in order to drive the discharge blocks B. Referring to FIG. 3, the backlight unit driver 700 of FIG. 1 may include a field-programmable gate array (FPGA) 710, first and second switching units 720 and 730, first and second voltage generation units 740 and 750, and first and second switching control units 760 and 770.

The FPGA 710 stores discharge/non-discharge data indicating whether each of two adjacent ones of the discharge blocks B of the surface light source 300 is discharged according to each combination of voltage levels of a first driving signal, a second driving signal, and a driving voltage that are provided to two corresponding ones of the first electrode lines 350 and a corresponding one of the second electrode lines 360 shown in FIGS. 2A and 2B. In addition, the FPGA 710 stores basic dimming data that includes combinations of the discharge/non-discharge data.

The FPGA 710 may combine the basic dimming data and output dimming control signals. Specifically, the FPGA 710 may combine the basic dimming data and output dimming control signals, which correspond to luminance distributions of two adjacent ones of the LCD panel blocks A, respectively, in order to simultaneously drive two adjacent ones of the discharge blocks B of the surface light source 300 that correspond to the two adjacent LCD panel blocks A. That is, the FPGA 710 may receive an image signal from an external source via the conversion unit 600, calculate luminances of image signals displayed on two adjacent LCD panel blocks A by using the received image signal, and output dimming control signals that correspond respectively to the calculated luminances by using the discharge/non-discharge data and the basic dimming data to control the first and second switching control unit 760 and 770, respectively.

The first switching unit 720 is disposed on one side of the surface light source 300, and the second switching unit 730 is disposed on another side of the surface light source 300. Each of the first and second switching units 720 and 730 includes a plurality of TFTs (not shown). The first switching unit 720 is connected to the first electrode lines 350 shown in FIGS. 2A and 2B that are formed on the lower substrate 320 of the surface light source 300, and the second switching unit 730 is connected to the second electrode lines 360 shown in FIGS. 2A and 2B that are formed on the upper substrate 310 of the surface light source 300.

Each of the first and second voltage generation units 740 and 750 is connected to the first and second switching units 720 and 730. The first and second voltage generation units 740 and 750 generate first and second voltages having different phases, respectively. Specifically, the first and second voltage generation units 740 and 750 may generate a positive voltage having a positive voltage level and a negative voltage having a negative voltage level, respectively. For example, the first voltage generation unit 740 may generate a positive voltage of 500 V, and the second voltage generation unit 750 may generate a negative voltage of −500 V. Therefore, the first and second voltages generated by the first and second voltage generation units 740 and 750, respectively, are selectively applied to the first and second electrode lines 350 and 360 of the surface light source 300 via the first and second switching units 720 and 730, respectively.

The first switching control unit 760 outputs signals for controlling the first switching unit 720 in response to an output signal of the FPGA 710. In response to the control signals output from the first switching control unit 760, the first switching unit 720 causes driving signals, each of which includes the first and second voltages generated by the first and second voltage generation units 720 and 730, respectively, and a ground voltage, to be provided to the first electrode lines 350 of the surface light source 300. In this exemplary embodiment, the driving signals transmitted to every two adjacent ones of the first electrode lines 350 of the surface light source 300 have different waveforms. That is, the first driving signal may be transmitted to any one of the first electrode lines 350, and the second driving signal having a different waveform from the first driving signal may be transmitted to another one of the first electrode lines 350 that is adjacent the above-mentioned first electrode line 350. For example, the first driving signal may be transmitted to odd-numbered ones of the first electrode lines 350, and the second driving signal may be transmitted to even-numbered ones of the first electrode lines 350.

The second switching control unit 770 outputs signals for controlling the second switching unit 730 in response to an output signal of the FPGA 710. In response to the control signals output from the second switching control unit 770, the second switching unit 730 allows the first voltage, the second voltage, or the ground voltage to be applied to a corresponding one of the second electrode lines 360 of the surface light source 300 according to the luminance of an image signal that is displayed on each LCD panel block A.

Referring to FIG. 3, the FPGA 710 may include a signal distributor 711, a luminance calculator 712, a dimming controller 713, and a memory 714.

The memory 714 may store discharge/non-discharge data and basic dimming data that includes combinations of the discharge/non-discharge data. The discharge/non-discharge data indicates whether each of two adjacent ones of the discharge blocks B of the surface light source 300 is discharged according to each combination of voltage levels of the first driving signal, the second driving signal, and the driving voltage that are provided to the two adjacent discharge blocks B in order to drive them. The basic dimming data may include combinations of the discharge/non-discharge data according to the respective luminances, that is, discharge rates, of the two adjacent discharge blocks B.

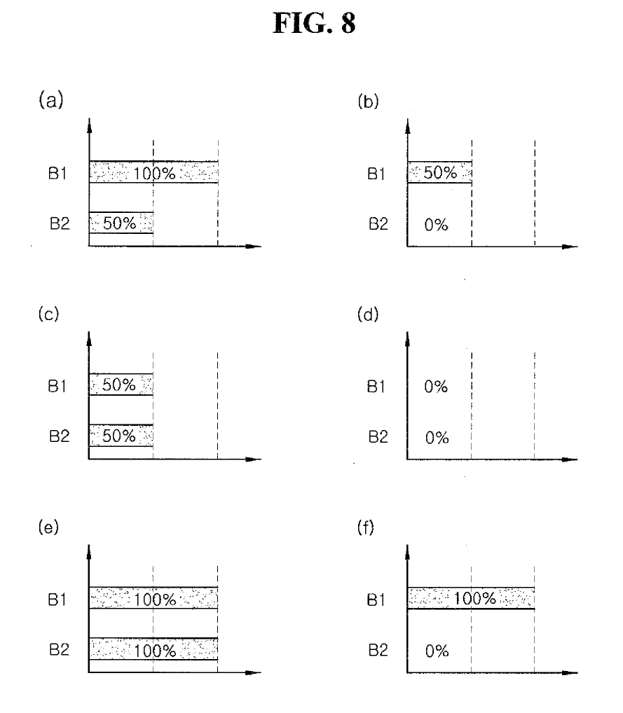

For example, the basic dimming data may include a 100/50 combination of the discharge/non-discharge data for discharging 100% of any one of two adjacent discharge blocks B, while discharging 50% of the other one of the two adjacent discharge blocks B, a 100/0 combination of the discharge/non-discharge data for discharging 100% any one of the two adjacent discharge blocks B, while discharging 0% of the other one of the two adjacent discharge blocks B, a 100/100 combination of the discharge/non-discharge data for discharging 100% of both of the two adjacent discharge blocks B, a 50/50 combination of the discharge/non-discharge data for discharging 50% of both of the two adjacent discharge blocks B, and a 0/0 combination of the discharge/non-discharge data for discharging 0% of both of the two adjacent discharge blocks B. The basic dimming data will be described in detail hereinbelow with reference to FIG. 8.

The signal distributor 711 receives an image signal via the conversion unit 600, extracts grayscale data of the received image signal, and provides the extracted grayscale data to the luminance calculator 712.

The luminance calculator 712 receives the grayscale data of the image signal from the signal distributor 711 and calculates the grayscale average of each LCD panel block A by using the received grayscale data. Then, the luminance calculator 712 calculates the luminance of each LCD panel block A based on the calculated grayscale average thereof. In this exemplary embodiment, the luminance calculator 712 calculates respective luminances of two vertically adjacent LCD panel blocks A and outputs luminance signals that correspond to the calculated luminances, respectively. That is, the luminance calculator 712 calculates the respective luminances of the two vertically adjacent LCD panel blocks A relative to a maximum luminance. For example, when the respective luminances of the two vertically adjacent LCD panel blocks A account for 60% and 20% of the maximum luminance, respectively, the luminance calculator 712 calculates the respective luminances of the two LCD panel blocks A and outputs luminance signals that correspond to the calculated luminances, respectively.

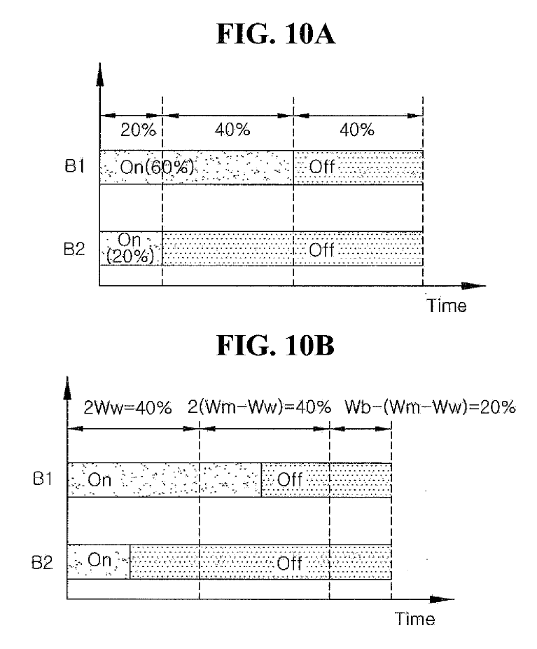

The dimming controller 713 receives the luminance signals from the luminance controller 712, reads the discharge/non-discharge data and the basic dimming data from the memory 714, creates detailed dimming data by using the read data, and outputs dimming control signals, which correspond to the detailed dimming data, to the first switching control unit 760 and the second switching control unit 770, respectively. In this exemplary embodiment, the detailed dimming data is dimming data that corresponds to various combinations of the length of time during which both of two adjacent discharge blocks B are discharged, the length of time during which any one of the two adjacent discharge blocks B is discharged, and the length of time during which none of the two adjacent discharge blocks B are discharged. The detailed dimming data will be described hereinbelow with reference to FIGS. 10 through 12.

That is, the luminance controller 713 may output dimming control signals, which correspond to luminance signals received from the luminance calculator 712, by using the discharge/non-discharge data and the basic dimming data. The dimming control signals output from the dimming controller 713 may control the power that is supplied to the discharge blocks B of the surface light source 300.

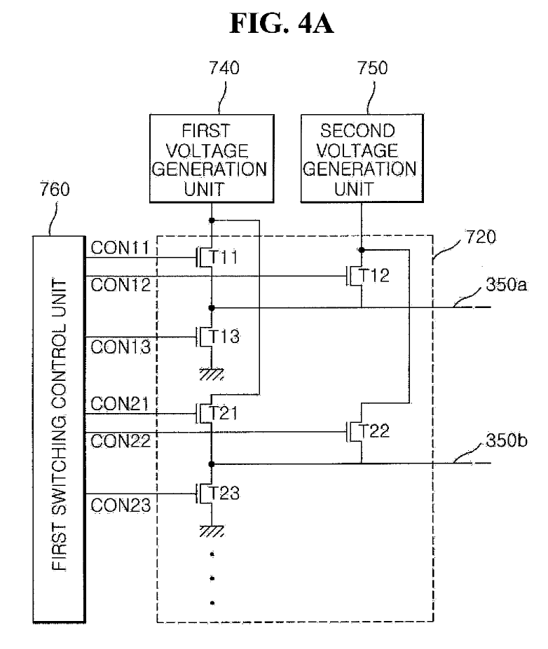

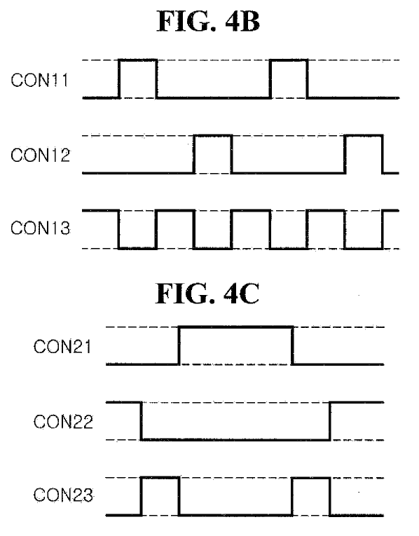

FIG. 4A is a schematic configuration diagram of the first switching unit 720 of FIG. 3 and its surroundings according to the exemplary embodiment of the present invention. FIG. 4B is a waveform diagram of control signals transmitted to control the waveform of the first driving signal. FIG. 4C is a waveform diagram of control signals transmitted to control the waveform of the second driving signal.

Referring to FIG. 4A, the first switching unit 720 according to an exemplary embodiment of the present invention includes a plurality of transistors. Three transistors are connected to each of the first electrode lines 350 of FIGS. 2A and 2B. Therefore, the number of transistors included in the first switching unit 720 is at least three times the number of the first electrode lines 350. For example, first, second, and third transistors T11, T12, and T13 are connected to a first first electrode line 350a, and fourth, fifth, and sixth transistors T21, T22, and T23 are connected to a second first electrode line 350b that is vertically adjacent the first first electrode line 350a. The first first electrode line 350a and the second first electrode line 350b form part of the first electrode lines 350.

The first transistor T11 is driven by a first control signal CON11 output from the first switching control unit 760 and applies the first voltage generated by the first voltage generation unit 740 to the first first electrode line 350a. The second transistor T12 is driven by a second control signal CON12 output from the first switching control unit 760 and applies the second voltage generated by the second voltage generation unit 750 to the first first electrode line 350a. In addition, the third transistor T13 is driven by a third control signal CON13 output from the first switching control unit 760 and connects the first first electrode line 350a to a ground terminal.

The fourth through sixth transistors T21 through T23 are connected to the second first electrode line 350b. The fourth transistor T21 is driven by a fourth control signal CON21 output from the first switching control unit 760 and applies the first voltage generated by the first voltage generation unit 740 to the second first electrode line 350b. The fifth transistor T22 is driven by a fifth control signal CON22 output from the first switching control unit 760 and applies the second voltage generated by the second voltage generation unit 750 to the second first electrode line 350b. The sixth transistor T23 is driven by a sixth control signal CON23 output from the first switching control unit 760 and connects the second first electrode line 350b to the ground terminal.

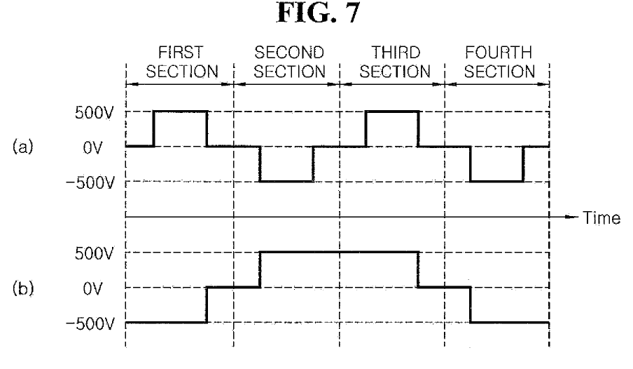

The first switching control unit 760 provides the first through third control signals CON11 through CON 3 having waveforms as shown in FIG. 4B and provides the fourth through sixth control signals CON21 through CON23 having waveforms as shown in FIG. 4C. When the first through third control signals CON11 through CON13 have the waveforms as shown in FIG. 4B, the first driving signal may have a waveform as shown at (a) in FIG. 7. In addition, when the fourth through sixth control signals CON21 through CON23 have the waveforms as shown in FIG. 4C, the second driving signal may have a waveform as shown at (b) in FIG. 7.

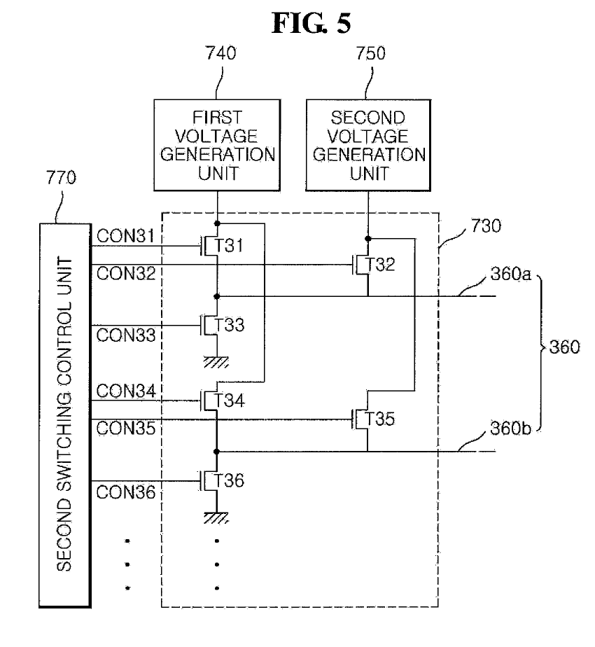

FIG. 5 is a schematic configuration diagram of the second switching unit 730 and its surroundings according to an exemplary embodiment of the present invention.

Referring to FIG. 5, the second switching unit 730 according to an exemplary embodiment of the present invention includes a plurality of transistors. Three transistors are connected to each of the second electrode lines 360 shown in FIGS. 2A and 2B. Therefore, the number of transistors included in the second switching unit 730 is at least three times the number of the second electrode lines 360. For ease of representation, the second electrode lines are shown to be horizontal, although they are actually orthogonal to the first electrode lines

A first transistor T31 is driven by a first control signal C31 output from the second switching control unit 770 and applies the first voltage generated by the first voltage generation unit 740 to a first second electrode line 360a. A second transistor T32 is driven by a second control signal CON32 output from the second switching control unit 770 and applies the second voltage generated by the second voltage generation unit 750 to the first second electrode line 360a. In addition, a third transistor T33 is driven by a third control signal CON33 output from the second switching control unit 770 and connects the first second electrode line 360a to the ground terminal.

Fourth, fifth, and sixth transistors T34, T35, and T36 are driven respectively by fourth, fifth and sixth control signals CON34, CON35, and CON36 output from the second switching control unit 770 and respectively apply the first voltage, the second voltage and the ground voltage to a second second electrode line 360b that is adjacent the first second electrode line 360a. The first second electrode line 360a and the second second electrode line 360b form part of the second electrode lines 360.

As described above, each of the second electrode lines 360a and 360b is connected to three transistors of the second switching unit 730. The three transistors connected to each of the second electrode lines 360a and 360b are driven respectively by control signals output from the second switching control unit 770. In this exemplary embodiment, the control signals output from the second switching control unit 770 may have different waveforms according to the luminance of an image displayed on each LCD panel block A.

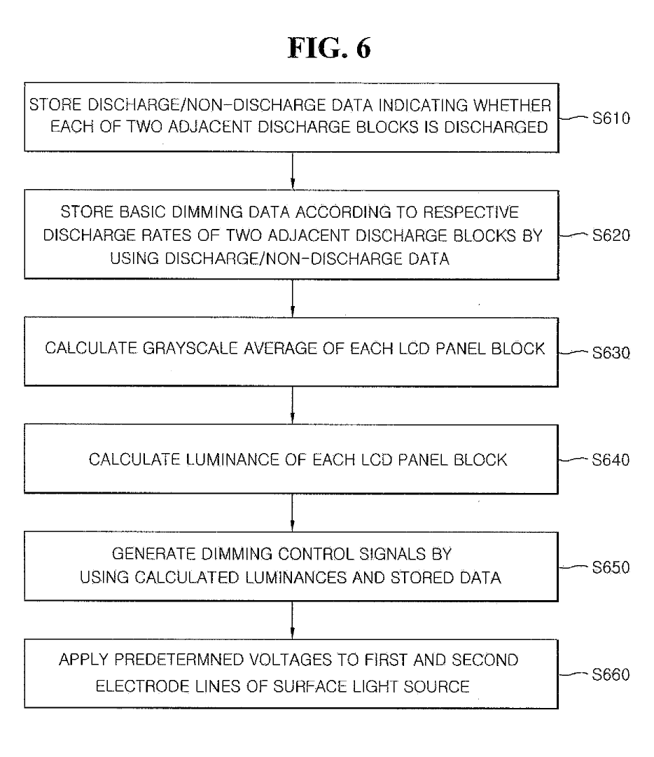

A method of dimming the LCD, which includes the backlight unit assembly using the surface light source 300 structured as described above, according to an exemplary embodiment of the present invention will now be described with reference to FIG. 6.

Referring to FIG. 6 for the method steps, as well as to FIGS. 2A, 3, 4A, and 5 for the circuit elements, the dimming method according to an exemplary embodiment of the present invention includes transmitting first and second driving signals having different waveforms to two adjacent ones of the first electrode lines 350, which correspond to two vertically adjacent ones of the discharge blocks B of the surface light source 300, respectively, applying a variable driving voltage to one of the second electrode lines 360 that corresponds to the two vertically adjacent discharge blocks B, and storing discharge/non-discharge data, which indicates whether each of the two vertically adjacent discharge blocks B is discharged according to each combination of voltage levels of the first driving signal, the second driving signal and the driving voltage, in the memory 714 of the FPGA 710 (operation S610) storing basic dimming data, which includes combinations of the discharge/non-discharge data according to the respective luminances, that is, discharge rates, of the two adjacent discharge blocks B, in the memory 714 (operation S620) extracting grayscale data of an image signal and calculating the grayscale average of each LCD panel block A by using the extracted grayscale data (operation S630), calculating the luminance of each LCD panel block A based on the calculated grayscale average thereof (operation S640), generating dimming control signals, which are used to control the power supplied to the discharge blocks B of the surface light source 300, by using the stored discharge/non-discharge data and basic dimming data (operation S650), and providing the first and second driving signals having predetermined voltage levels and a driving voltage having a predetermined level respectively to two of the first electrode lines 350 and one of the second electrode lines 360, which correspond to two adjacent ones of the discharge blocks B of the surface light source 300, via the first and second switching units 720 and 730 that are driven by controls signals output from the first and second switching control units 760 and 770, respectively, in response to the dimming control signals (operation S660).

Specifically, in operation S610, first and second driving signals having different waveforms are transmitted to two vertically adjacent ones of the first electrode lines 350 of the surface light source 300, and a predetermined voltage is applied to one of the second electrode lines 360 that corresponds to the two vertically adjacent first electrode lines 350. Each of the first driving signal and the second driving signal may include a positive voltage having a positive voltage level, a negative voltage having a negative voltage level, and a ground voltage. The waveform of the first driving signal may have a first duty ratio and a first frequency, and that of the second driving signal may have a second duty ratio, which is higher than the first duty ratio, and a second frequency that is lower than the first frequency. Here, duty ratio refers to a ratio of the length of time, during which a positive voltage or a negative voltage is applied, to the total length of time during which each driving signal is transmitted. In order to transmit the first and second driving signals having waveforms as shown (a) and (b) in FIG. 7, the first and second switching control units 760 and 770 may transmit control signals having waveforms, as shown in FIGS. 4B and 4C.

The first driving signal may have, for example, an amplitude of 500 V and a first duty ratio of 50% as shown at (a) in FIG. 7. That is, a first voltage of 500 V and a second voltage of −500 V may be alternately and repeatedly applied at a duty ratio of 50%. In addition, the second driving signal may have, for example, an amplitude of 500 V and a second duty ratio of 75% as shown at (b) in FIG. 7. That is, the first voltage of 500 V and the second voltage of −500 V may be alternately and repeatedly applied at a duty ratio of 75%.

More specifically, referring to the first driving signal (a) of FIG. 7, a ground voltage is applied during the initial 25% of a first section, the first voltage of 500 V is applied during the next 50% of the first section, and the ground voltage is applied again during the remaining 25% of the first section. Then, the ground voltage is applied during the initial 25% of a second section, the second voltage of −500 V is applied during the next 50% of the second section, and the ground voltage is applied during the remaining 25% of the second section. Next, the ground voltage is applied during the initial 25% of a third section, the first voltage of 500 V is applied during the next 50% of the third section, and the ground voltage is applied during the remaining 25% of the third section. Then, the ground voltage is applied during the initial 25% of a fourth section, the second voltage of −500 V is applied during the next 50% of the fourth section, and the ground voltage is applied during the remaining 25% of the fourth section. Thus, it is seen that each section is formed of subsections.

Referring to the second driving signal (b) of FIG. 7, the second voltage of −500. V is applied during the initial 75% of the first section, and the ground voltage is applied during the remaining 25% of the first section. Then, the ground voltage is applied during the initial 25% of the second section, and the first voltage of 500 V is applied during the remaining 75% of the second section. Next, the first voltage of 500 V is applied during the initial 75% of the third section, and the ground voltage is applied during the remaining 25% of the third section. Then, the ground voltage is applied during the initial 25% of the fourth section, and the second voltage of −500 V is applied during the remaining 75% of the fourth section.

There may be four combinations of voltage levels of the first and second driving signals. As shown in (a) and (b) of FIG. 7, the four combinations may be the first section in which the first driving signal has a positive voltage level and the second driving signal has a negative voltage level, the second section in which the first driving signal has a negative voltage level and the second driving signal has a positive voltage level, the third section in which both of the first and second driving signals have positive voltage levels, and the fourth section in which both of the first and second driving signals have negative voltage levels.

The discharge/non-discharge data may indicate whether each of two discharge blocks B is discharged in each of the first through fourth sections according to the voltage level of a driving voltage. Hereinafter, it will be assumed that a discharge block B defined in a region, where a first electrode line 350 and a second electrode line 360 cross each other, is discharged when a voltage difference between the first electrode line 350 and the second electrode line 360 is 1000 V.

Each of two adjacent discharge blocks B is discharged or undischarged in each of the first through fourth sections, which are the four combinations of the voltage levels of the first and second driving signals transmitted to the first electrode lines 350 of the two adjacent discharge blocks B, according to the voltage level of a driving voltage that is applied to the second electrode line 360 of the two adjacent discharge blocks B.

Table 1 shows data indicating whether each of two vertically adjacent discharge blocks B, which will be referred to as first and second discharge blocks in the following description of Table 1, is discharged according to the first and second driving signals, which are transmitted to two first electrode lines 350 corresponding to the vertically adjacent first and second discharge blocks B, respectively, and the driving voltage that is applied to a second electrode line 360 corresponding to the vertically adjacent first and second discharge blocks B.

TABLE 1

| Second Electrode | First Electrode | First | Second | Third | Fourth |
|---|---|---|---|---|---|
| Line | Line | Section | Section | Section | Section |
| | | Case 1 | Case 2 | Case 3 | Case 4 |
| Positive voltage | Odd-numbered | Off | On | Off | On |
| (500 V) | Even-numbered | On | Off | Off | On |
| | | Case 5 | Case 6 | Case 7 | Case 8 |
| Negative voltage | Odd-numbered | On | Off | On | Off |
| (−500 V) | Even-numbered | Off | On | On | Off |
| | | Case 9 | Case 10 | Case 11 | Case 12 |
| Ground voltage | Odd-numbered | Off | Off | Off | Off |
| (0 V) | Even-numbered | Off | Off | Off | Off |

Referring to Table 1, when the first and second driving signals are transmitted to the first electrode lines 350 of the vertically adjacent first and second discharge blocks B, respectively, and when 500 V is applied to the second electrode line 360 of the first and second discharge blocks B, the second discharge block B is discharged in the first section (case 1), the first discharge block B is discharged in the second section (case 2), none of the first and second discharge blocks B are discharged in the third section (case 3), and both of the first and second discharge blocks B are discharged in the fourth section (case 4).

When the first and second driving signals are transmitted to the first electrode lines 350 of the first and second discharge blocks B, respectively, and when −500 V is applied to the second electrode line 360, the first discharge block B is discharged in the first section (case 5), the second discharge block B is discharged in the second section (case 6), both of the first and second discharge blocks B are discharged in the third section (case 7), and none of the first and second discharge blocks B are discharged in the fourth section (case 8).

When the first and second driving signals are transmitted to the first electrode lines 350 of the first and second discharge blocks B, respectively, and when the ground voltage is applied to the second electrode line 360, none of the first and second discharge blocks B are discharged in each of the first through fourth sections (cases 9 through 12).

Discharge/non-discharge data indicating whether each of the first and second discharge blocks B is discharged in each of the first through fourth sections according to the voltage level of the driving voltage, that is, the data shown in Table 1 above, is stored in the memory 714 of the FPGA 710 shown in FIG. 3.

In operation S620 of FIG. 6, basic dimming data, which includes combinations of the data shown in Table 1, that is, the discharge/non-discharge data, is stored in the memory 714. The basic dimming data may include combinations of the discharge/non-discharge data according to the respective luminances, that is, discharge rates, of two vertically adjacent discharge blocks B. Specifically, the basic dimming data may include a 100/50 combination of the discharge/non-discharge data for discharging 100% of any one of two vertically adjacent discharge blocks B, while discharging 50% of the other one of the two vertically adjacent discharge blocks B, a 100/0 combination of the discharge/non-discharge data for discharging 100% of any one of the two vertically adjacent discharge blocks B, while discharging 0% of the other one of the two vertically adjacent discharge blocks B, a 100/100 combination of the discharge/non-discharge data for discharging 100% of both of the two vertically adjacent discharge blocks, a 50/50 combination of the discharge/non-discharge data for discharging 50% of both of the two vertically adjacent discharge blocks, and a 0/0 combination of the discharge/non-discharge data for discharging 0% of both of the two vertically adjacent discharge blocks.

The memory 714 may store detailed dimming data, which includes combinations of the basic dimming data, in addition to the basic dimming data. The detailed dimming data includes various combinations of the basic dimming data, that is, various combinations of the length of time during which both of the two vertically adjacent discharge blocks B are discharged, the length of time during which any one of the two vertically adjacent discharge blocks B is discharged, and the length of time during which none of the two vertically adjacent discharge blocks B is discharged.

A method of generating the basic dimming data by combining the discharge/non-discharge data will now be described. Basic combinations of the discharge/non-discharge data for simultaneously driving two vertically adjacent discharge blocks B are schematically illustrated in (a) through (f) of FIG. 8.

(a) in FIG. 8 schematically illustrates a 100/50 combination in which a discharge block B1 is discharged 100% while another discharge block B2 vertically adjacent to the discharge block B1 is discharged 50%, that is, a combination in which an LCD panel block A corresponding to the discharge block B1 has a maximum luminance during a frame while another LCD panel block A corresponding to the discharge block B2 has 50% of the maximum luminance. In this example, a frame is divided into four sections. In the order of case 5, case 2, case 7, and case 4 of Table 1 described above, the first driving signal is transmitted to the first electrode line 350 of the discharge block B1, and the second driving signal is transmitted to the first electrode line 350 of the discharge block B2. In addition, −500 V, 500 V, −500 V, and 500 V are applied to the second electrode line 360 of the discharge blocks B1 and B2 in the four sections, respectively.

(b) in FIG. 8 schematically illustrates a 50/0 combination in which the discharge block B1 is discharged 50% while the discharge block B2 is not discharged. In this example, a frame is divided into four sections. In the order of case 5, case 2, case 11 and case 12 of Table 1, the first driving signal is transmitted to the first electrode line 350 of the discharge block B1, and the second driving signal is transmitted to the first electrode line 350 of the discharge block B2. In addition, −500 V, 500 V, the ground voltage, and the ground voltage are applied to the second electrode line 360 of the discharge blocks B1 and B2 in the four sections, respectively.

(c) in FIG. 8 schematically illustrates a 50/50 combination in which both of the discharge blocks B1 and B2 are discharged 50%. In this example, a frame is divided into four sections. Then, in the order of case 1, case 2, case 3 and case 4 of Table 1, the first and second driving signals are transmitted to the first electrode lines 350 of the discharge blocks B1 and B2, respectively, and 500 V is applied to the second electrode line 360 of the discharge blocks B1 and B2 in all of the four sections.

(d) in FIG. 8 schematically illustrates a 0/0 combination in which the discharge blocks B1 and B2 are not discharged. In this case, a frame is divided into four sections. Then, in the order of case 9, case 10, case 11 and case 12 of Table 1, the first and second driving signals are transmitted to the first electrode lines 350 of the discharge blocks B1 and B2, respectively, and the ground voltage is applied to the second electrode line 360 of the discharge blocks B1 and B2 in all of the four sections.

(e) in FIG. 8 schematically illustrates a 100/100 combination in which both of the discharge blocks B1 and B2 are discharged 100%. In this case, a frame is divided into four sections. Then, in the order of case 1, case 2, case 7 and case 4 of Table 1, the first and second driving signals are transmitted to the first electrode lines 350 of the discharge blocks B1 and B2, respectively, and 500 V, 500V, −500 V and 500 V are applied to the second electrode line 360 of the discharge blocks B1 and B2 in the four sections, respectively. Here, both of the discharge blocks B1 and B2 can be discharged up to 75%. That is, none of the discharge blocks B1 and B2 can be discharged up to 100%. The luminances of LCD panel blocks (corresponding to the discharge blocks B1 and B2), however, can be enhanced by 50% as compared to when a conventional scanning method is used.

(f) in FIG. 8 schematically illustrates a 100/0 combination in which the discharge block B1 is discharged 100% while the discharge block B2 is not discharged. In this example, a frame is divided into four sections. Then, in the order of case 5, case 2, case 3 and case 4 of Table 1, the first and second driving signals are transmitted to the first electrode lines 350 of the discharge blocks B1 and B2, respectively, and −500 V, 500 V, −500 V and −500 V are applied to the second electrode line 360 of the discharge blocks B1 and B2 in the four sections, respectively. Here, the discharge block B1 can be discharged up to 75%. That is, the discharge block B1 cannot be discharged up to 100%. The 100/0 combination of (f) in FIG. 8, however, is applicable because the luminances (of the LCD panel blocks A corresponding to the discharge blocks B1 and B2) can be enhanced by 50% as compared to when the conventional scanning method is used.

As described above, data created by combining the cases of Table 1 according to the states of the discharge blocks B1 and B2 may be stored in the memory 714 of the FPGA 710 of FIG. 3.

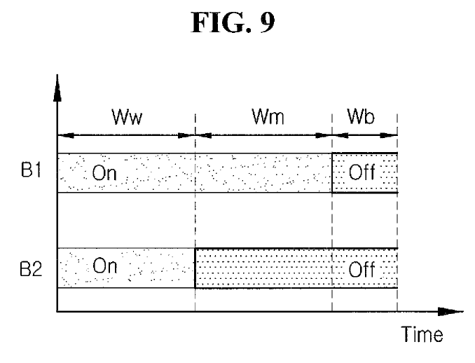

In addition to the above basic combinations of the discharge/non-discharge data for the discharge blocks B1 and B2, various combinations may be made according to whether each of the discharge blocks B1 and B2 is discharged in each section. Specifically, FIG. 9 schematically illustrates the discharge or non-discharge state of each of the discharge blocks B1 and B2 in each section. Referring to FIG. 9, a frame may be divided into a section Ww in which both of the two vertically adjacent discharge blocks B1 and B2 are discharged, a section Wm in which only one of the discharge blocks B1 and B2 is discharged, and a section Wb in which none of the discharge blocks B1 and B2 is discharged. When a frame is divided into the above three sections Ww, Wm and Wb, the discharge blocks B1 and B2 may be driven in various ways according to the relationship between the sections Ww, Wm and Wb.

More specifically, when the section Wm in which only one of the discharge blocks B1 and B2 is discharged is longer than the sum of the section Ww in which both of the discharge blocks B1 and B2 is discharged and the section Wb in which none of the discharge blocks B1 and B2 are discharged, that is, Wm>Ww+Wb, the discharge blocks B1 and B2 are driven as shown at (a) in FIG. 8 for twice longer than the section Wm in which only one of the discharge blocks B1 and B2 is discharged. Then, the discharge blocks B1 and B2 are driven as shown at (b) in FIG. 8 for twice longer than the section Wb in which none of the discharge blocks B1 and B2 are discharged. Next, the discharge blocks B1 and B2 are driven as shown at (f) in FIG. 8 for the length of time obtained by subtracting the section Ww in which both of the discharge blocks B1 and B2 are discharged from the section Wm in which only one of the discharge blocks B1 and B2 is discharged and then subtracting the section Wb in which none of the discharge blocks B1 and B2 is discharged from the subtraction result. The above situation may be briefly summarized as follows.

Class I) Wm>Ww+Wb

Process 1: driven as shown at (a) in FIG. 8 for 2Ww (case 5->case 2->case 7->case 4)

Process 2: driven as shown at (b) in FIG. 8 for 2Wb (case 5->case 2->case 11->case 12)

Process 3: driven as shown at (f) in FIG. 8 for Wm−Ww−Wb (case 5->case 2->case 3->case 4)

When the sum of the section Ww in which both of the discharge blocks B1 and B2 are discharged and the section Wb in which none of the discharge blocks B1 and B2 is discharged is longer than the section Wm in which only one of the discharge blocks B1 and B2 is discharged (Wm<Ww+Wb), the discharge blocks B1 and B2 may be driven in various ways as follows.

First, when the section Ww in which both of the discharge blocks B1 and B2 are discharged is longer than the section Wm in which only one of the discharge blocks B1 and B2 is discharged (Wm<Ww) and when the difference between the section Ww in which both of the discharge blocks B1 and B2 are discharged and the section Wm in which only one of the discharge blocks B1 and B2 is discharged is longer than the section Wb in which none of the discharge blocks B1 and B2 is discharged (Ww−Wm>Wb), the discharge blocks B1 and B2 are driven as shown at (a) in FIG. 8 for twice longer than the section Wm in which only one of the discharge blocks B1 and B2 is discharged. Then, the discharge blocks B1 and B2 are driven as shown at (c) in FIG. 8 for twice longer than the section Wb in which none of the discharge blocks B1 and B2 are discharged. Next, the discharge blocks B1 and B2 are driven as shown at (e) in FIG. 8 for the length of time obtained by subtracting the section Wm in which only one of the discharge blocks B1 and B2 is discharged from the section Ww in which both of the discharge blocks B1 and B2 are discharged and then subtracting the section Wb in which none of the discharge blocks B1 and B2 are discharged from the subtraction result.

Second, when the section Ww in which both of the discharge blocks B1 and B2 are discharged is longer than the section Wm in which only one of the discharge blocks B1 and B2 is discharged (Wm<Ww) and when the difference between the section Ww in which both of the discharge blocks B1 and B2 are discharged and the section Wm in which only one of the discharge blocks B1 and B2 is discharged is shorter than the section Wb in which none of the discharge blocks B1 and B2 is discharged (Ww−Wm<Wb), the discharge blocks B1 and B2 are driven as shown at (a) in FIG. 8 for twice longer than the section Wm in which only one of the discharge blocks B1 and B2 is discharged. Then, the discharge blocks B1 and B2 are driven as shown at (c) in FIG. 8 for twice longer than the length of time obtained by subtracting the section Wm in which only one of the discharge blocks B1 and B2 is discharged from the section Ww in which both of the discharge blocks B1 and B2 are discharged. Next, the discharge blocks B1 and B2 are driven as shown in FIG. 81D for the length of time obtained by subtracting the section Wm in which only one of the discharge blocks B1 and B2 is discharged from the section Wb in which none of the discharge blocks B1 and B2 is discharged and then adding the section Ww in which both of the discharge blocks B1 and B2 are discharged to the subtraction result.

Third, when the sum of the section Ww in which both of the discharge blocks B1 and B2 are discharged and the section Wb in which none of the discharge blocks B1 and B2 are discharged is longer than the section Wm in which only one of the discharge blocks B1 and B2 is discharged (Wm<Ww+Wb) and when the section Wm in which only one of the discharge blocks B1 and B2 is discharged is longer than the section Ww in which both of the discharge blocks B1 and B2 are discharged (Wm>Ww), the discharge blocks B1 and B2 are driven as shown at (a) in FIG. 8 for twice longer than the section Ww in which both of the discharge blocks B1 and B2 are discharged. Then, the discharge blocks B1 and B2 are driven as shown at (b) in FIG. 8 for twice longer than the length of time obtained by subtracting the section Ww in which both of the discharge blocks B1 and B2 are discharged from the section Wm in which only one of the discharge blocks B1 and B2 is discharged and then adding the section Ww in which both of the discharge blocks B1 and B2 are discharged to the subtraction result. The above situation may be briefly summarized as follows.

Class II) Wm<Ww+Wb

Case 1: Wm<Ww, Ww−Wm>Wb

Process 1: driven as shown at (a) in FIG. 8 for 2Wm (case 5->case 2->case 7->case 4)

Process 2: driven as shown at (c) in FIG. 8 for 2Wb (case 1->case 2->case 3->case 4)

Process 3: driven as shown in at (e) FIG. 8 for Ww−Wm−Wb (case 1->case 2->case 7->case 4)

Case 2: Wm<Ww, Ww−Wm<Wb

Process 1: driven as shown at (a) in FIG. 8 for 2Wm (case 5->case 2->case 7->case 4)

Process 2: driven as shown at (c) in FIG. 8 for 2(Ww−Wm) (case 1->case 2->case 3->case 4)

Process 3: driven as shown at (d) in FIG. 8 for Wb−(Ww−Wm) (case 9->case 10->case 11->case 12)

Case 3: Wm>Ww

Process 1: driven as shown at (a) in FIG. 8 for 2Ww (case 5->case 2->case 7->case 4)

Process 2: driven as shown at (b) in FIG. 8 for 2(Wm−Ww) (case 5->case 2->case 11->case 12)

Process 3: driven as shown at (d) in FIG. 8 for Wb−(Wm−Ww) (case 9->case 10->case 11->case 12)

In operation S630 shown in FIG. 6, after the basic data, which includes combinations of the discharge/non-discharge data indicating whether each of two vertically adjacent discharge blocks is discharged, and the altered data, which is created by using the basic data, are stored in the memory 714 shown in FIG. 3, the signal distributor 711 receives an image signal via the conversion unit 600, extracts grayscale data of the image signal, and provides the extracted grayscale data of the image signal to the luminance calculator 712.

In operation S640, the luminance calculator 712 receives the extracted grayscale data of the image signal from the signal distributor 711 and calculates the grayscale average of each LCD panel block A by using the received grayscale data. In addition, the luminance calculator 712 calculates the luminance of each LCD panel block A based on the calculated grayscale average thereof. In this exemplary embodiment, the luminance calculator 712 calculates respective luminances of two vertically adjacent LCD panel blocks A and generates luminance signals that correspond to the calculated luminances, respectively.

That is, the luminance calculator 712 calculates the respective luminances of the two vertically adjacent LCD panel blocks A relative to a maximum luminance. For example, when the respective luminances of the two vertically adjacent LCD panel blocks A account for 60% and 20% of the maximum luminance, respectively, the luminance calculator 712 calculates the respective luminances of the two vertically adjacent LCD panel blocks A and outputs luminance signals that correspond to the calculated luminances, respectively.

In operation S650, the luminance signals output from the luminance calculator 712 are input to the dimming controller 713. The dimming controller 713 generates dimming control signals by using the luminance signals received from the luminance calculator 712 and the data stored in the memory 714 to control the power supplied to two vertically adjacent ones of the discharge blocks B of the surface light source 300 that correspond to the two vertically adjacent LCD panel blocks A, respectively. Then, the dimming controller 713 outputs the generated dimming control signals to the first and second switching control units 760 and 770, respectively. That is, the luminance controller 712 reads data, which corresponds to the luminance signals, from the memory 714, generates driving signals that correspond to the read data, and outputs the generated driving signals to the first and second switching control units 760 and 770.

In operation S660, each of the first and second switching control units 760 and 770, which receive the dimming control signals, respectively, outputs a plurality of control signals having the waveforms shown in FIGS. 4B and 4C. The output control signals drive each of the first and second switching units 720 and 730. Thus, a driving signal having a first waveform shown at (a) in FIG. 7 is transmitted to the first electrode line 350 of one of the two vertically adjacent discharge blocks B of the surface light source 300, and another driving signal having a second waveform shown at (b) in FIG. 7 is transmitted to the first electrode line 350 of the other one of the two vertically adjacent discharge blocks B. In addition, a predetermined voltage is applied to the second electrode line 360 of the two vertically adjacent discharge blocks B in order to discharge or not to discharge each of the two vertically adjacent display blocks B according to the respective luminances of the two vertically adjacent LCD panel blocks A that correspond to the two vertically adjacent discharge blocks B, respectively.

FIGS. 10A and 10B schematically illustrate the proportion of each section, in which each of the discharge blocks B1 and B2 is discharged or undischarged, in a frame according to an exemplary embodiment of the present invention. Specifically, FIGS. 10A and 10B schematically illustrate a case where respective luminances of two vertically adjacent LCD panel blocks A calculated by the luminance calculator 712 account for 60% and 20% of the maximum luminance, respectively.

When the respective luminances of the two vertically adjacent LCD panel blocks A account for 60% and 20% of the maximum luminance, respectively, the corresponding discharge blocks B1 and B2 are discharged 60% and 20%, respectively. In this case, the section Ww in which both of the discharge blocks B1 and B2 are discharged accounts for 20% of a frame, the section Wm in which only one of the discharge blocks B1 and B2 is discharged accounts for 40% of the frame, and the section Wb in which none of the discharge blocks B1 and B2 is discharged accounts for 40% of the frame. The proportions of the sections Ww, Wm and Wb correspond to Case 3 (Wm>Ww) of Class II (Wm<Ww+Wb) of the data stored in the memory 714.

Therefore, referring to FIG. 10B, the discharge blocks B1 and B2 are driven as shown at (a) in FIG. 8 for twice longer than the section Ww in which both of the discharge blocks B1 and B2 are discharged, that is, for the 40% of a frame. Then, the discharge blocks B1 and B2 are driven as shown at (b) in FIG. 8 for twice longer than the length of time obtained by subtracting the section Ww in which both of the discharge blocks B1 and B2 are discharged from the section Wm in which only one of the discharge blocks B1 and B2 is discharged, that is, for 2(Wm−Ww)=40% of the frame. Next, the discharge blocks B1 and B2 are driven as shown at (d) in FIG. 8 for the length of time obtained by subtracting the section Ww in which both of the discharge blocks B1 and B2 are discharged from the section Wm in which only one of the discharge blocks B1 and B2 is discharged and then subtracting the section Wb in which none of the discharge blocks B1 and B2 are discharged from the subtraction result, that is, for Wb−(Wm−Ww)=20% of the frame.

That is, the first and second driving signals are transmitted to the first electrode lines 350 of the discharge blocks B1 and B2, respectively. Then, during the initial 40% of the frame, driving voltages, which correspond to case 5, case 2, case 7 and case 4 of Table 1, respectively, are sequentially and repeatedly applied to the second electrode line 360 of the discharge blocks B1 and B2. During the next 40% of the frame, driving voltages, which correspond to case 5, case 2, case 11 and case 12 of Table 1, respectively, are sequentially and repeatedly applied to the second electrode line 360. During the remaining 20% of the frame, driving voltages, which correspond to case 9, case 10, case 11 and case 12 of Table 1, respectively, are sequentially and repeatedly applied to the second electrode line 360. That is, −500 V, 500 V, −500 V and 500 V are sequentially and repeatedly applied to the second electrode line 360 during the initial 40% of the frame, −500 V, 500 V, 0 V and 0 V are sequentially and repeatedly applied to the second electrode line 360 during the next 40% of the frame, and 0 V is repeatedly applied to the second electrode line 360 during the remaining 20% of the frame.

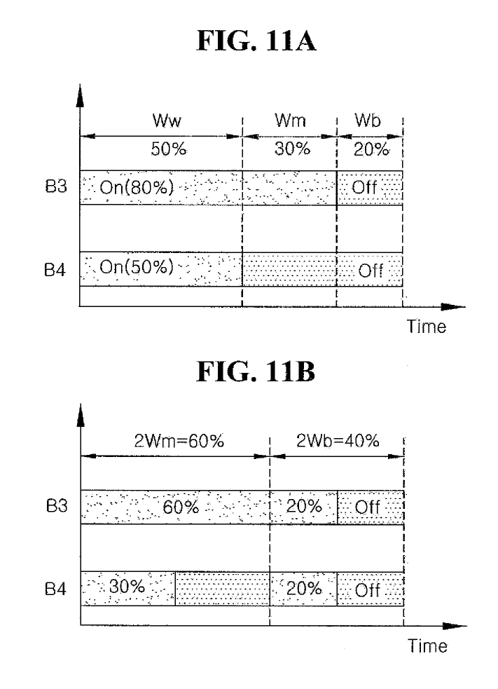

While the two vertically adjacent discharge blocks B1 and B2 are dimmed as shown in FIGS. 10A and 10B, another two discharge blocks B3 and B4 which are horizontally adjacent to the discharge blocks B1 and B2, respectively, may be simultaneously dimmed by using different values. For example, referring to FIG. 11A, when the discharge block B3 horizontally adjacent the discharge block B1 is discharged 80% and when the discharge block B4 horizontally adjacent the discharge block B2 is discharged 50%, the section Ww in which both of the discharge blocks B3 and B4 are discharged accounts for 50% of a frame, the section Wm in which only one of the discharge blocks B3 and B4 is discharged accounts for 30% of the frame, and the section Wb during which none of the discharge blocks B3 and B4 are discharged accounts for 20% of the frame, which corresponds to Case 1 (Wm<Ww) of Class II (Wm<Ww+Wb) of the data stored in the memory 714.

In this case, referring to FIG. 11B, the discharge blocks B3 and 34 are driven as shown at (a) in FIG. 8 for twice longer than the section Wm in which only one of the discharge blocks B3 and B4 is discharged, that is, for 2Wm=60% of the frame. Then, the discharge blocks B3 and B4 are driven as shown at (c) in FIG. 8 for twice longer than the section Wb in which none of the discharge blocks B3 and B4 are discharged, that is, for 2Wb=40% of the frame. Next, the discharge blocks B3 and B4 are not driven because the length of time obtained by subtracting the section Wm in which only one of the discharge blocks B3 and B4 is discharged and the section Wb in which none of the discharge blocks B3 and B4 is discharged from the section Ww in which both of the discharge blocks B3 and B4 are discharged (that is, Ww−Wm−Wb) accounts for 0% of the frame.

That is, the first and second driving signals are transmitted to the first electrode lines 350 of the discharge blocks B3 and B4, respectively. Then, during the initial 60% of the frame, driving voltages, which correspond to case 5, case 2, case 7 and case 4 of Table 1, respectively, are sequentially and repeatedly applied to the second electrode line 360 of the discharge blocks B3 and B4. During the next 40% of the frame, driving voltages, which correspond to case 1, case 2, case 3 and case 4 of Table 1, respectively, are sequentially and repeatedly applied to the second electrode line 360. That is, −500 V, 500 V, −500 V and 500 V are sequentially and repeatedly applied to the second electrode line 360 of the discharge blocks B3 and B4 during the initial 60% of the frame, and 500 V is repeatedly applied to the second electrode line 360 during the next 40% of the frame.

As described above, according to exemplary embodiments of the present invention, a surface light source includes a plurality of discharge blocks, a plurality of first electrode lines that are separated from each other in a horizontal direction, and a plurality of second electrode lines that are separated from each other in a vertical direction. A first driving signal and a second driving signal having a different waveform from the first driving signal are transmitted to two first electrode lines corresponding to two vertically adjacent ones of the discharge blocks, respectively.

Then, discharge/non-discharge data, which indicates whether each of the two vertically adjacent discharge blocks is discharged according to each combination of voltage levels of the first driving signal, the second driving signal and a driving voltage, is stored in a memory. In addition, basic dimming data, which includes combinations of the discharge/non-discharge data, is stored in the memory. Dimming control signals are generated by combining the basic dimming data based on the result of comparing the length of time during which both of the two adjacent discharge blocks are discharged, the length of time during which any one of the two adjacent discharge blocks is discharged, and the length of time during which none of the two adjacent discharge blocks is discharged.

Furthermore, respective luminances of two vertically adjacent LCD panel blocks are calculated based on an image signal. The first and second driving signals and the driving voltage, which correspond to the dimming control signals, are provided to two discharge blocks, which correspond to the two vertically adjacent LCD panel blocks, respectively, by using the discharge/non-discharge data and the basic dimming data stored in the memory in order to simultaneously drive the discharge blocks. Then, dimming control signals, which correspond to the calculated luminances, are generated by using the discharge/non-discharge data and the basic dimming data stored in the memory. Next, the first and second signals and the driving voltage that correspond to the generated dimming control signals, are provided to two discharge blocks that correspond to the two vertically adjacent LCD panel blocks, respectively, in order to simultaneously drive the two discharge blocks.

In this way, two vertically adjacent discharge blocks can be simultaneously driven during local dimming. Consequently, the local dimming capability can be enhanced even when local dimming and scanning are performed simultaneously, and a reduction in the luminances of LCD panel blocks due to scanning can be prevented.

While the present invention has been particularly shown and described with reference to exemplary embodiments thereof, it will be understood by those of ordinary skill in the art that various changes in form and detail may be made therein without departing from the spirit and scope of the present invention, as defined by the following claims. The exemplary embodiments should be considered in a descriptive sense only and not for purposes of limitation.

What is claimed is:

1. A backlight unit assembly comprising:
a surface light source that comprises a plurality of first electrode lines extending in a first direction, a plurality of second electrode lines insulated from the first electrode lines and extending in a second direction, and a plurality of discharge blocks defined in regions where the plurality of first electrode lines and the plurality of second electrode lines respectively cross each other;
a memory that stores discharge/non-discharge data indicating whether each of two adjacent ones of the plurality of discharge blocks is discharged according to each combination of voltage levels of a first driving signal, a second driving signal, and a driving voltage that are provided to a region in which the two adjacent ones of the plurality of discharge blocks are defined;
a luminance calculator that calculates luminances of a selected region based on an image signal; and
a dimming controller that outputs dimming control signals corresponding to the calculated luminances by using the discharge/non-discharge data stored in the memory,
wherein the first driving signal is transmitted to any one of the first electrode lines, the second driving signal having a different waveform from the first driving signal is transmitted to another one of the first electrode lines that is adjacent the first electrode line having the first driving signal transmitted thereto, and the driving voltage is applied to one of the second electrodes lines that crosses the two first electrode lines that have the first and second driving signals transmitted thereto, and the first and second driving signals and the driving voltage are adjusted according to the dimming control signals and provided to the surface light source.

2. The backlight unit assembly of claim 1, wherein the surface light source comprises:
an upper substrate and a lower substrate facing each other; and
a plurality of first and second sidewalls interposed between the upper and lower substrates and crossing each other, wherein
the plurality of discharge blocks are defined by the first and second sidewalls, respectively, and are filled with a discharge gas, wherein
the first electrode lines are formed on the lower substrate, are separated from each other, and extend in the first direction to pass out of the discharge blocks, and wherein
the second electrode lines are formed on the upper substrate, are separated from each other, and extend in the second direction to pass out of the discharge blocks.

3. The backlight unit assembly of claim 1, further comprising:
first and second voltage generation units that generate a positive voltage having a positive voltage level and a negative voltage having a negative voltage level, respectively;
a first switching unit that is connected to the first voltage generation unit, the second voltage generation unit and a ground terminal and controls a waveform of the first driving signal and a waveform of the second driving signal;
a second switching unit that is connected to the first voltage generation unit, the second voltage generation unit and a ground terminal and controls the voltage level of the driving voltage;
a first switching control unit that outputs signals for controlling the first switching unit in response to the dimming control signal; and
a second switching control unit that outputs signals for controlling the second switching unit in response to the dimming control signal.

4. The backlight unit assembly of claim 3, wherein the first switching unit comprises a first transistor connected between each of the first electrode lines and the first voltage generation unit, a second transistor connected between each of the first electrode lines and the second voltage generation unit, and a third transistor connected between each of the first electrode lines and the ground terminal.

5. The backlight unit assembly of claim 3, wherein the second switching unit comprises a first transistor connected between each of the second electrode lines and the first voltage generation unit, a second transistor connected between each of the second electrode lines and the second voltage generation unit, and a third transistor connected between each of the second electrode lines and the ground terminal.

6. The backlight unit assembly of claim 1, wherein each of the first driving signal and the second driving signal comprises a positive voltage having a positive voltage level, a negative voltage having a negative voltage level, and a ground voltage, and the waveform of the first driving signal has a first duty ratio and a first frequency, and the waveform of the second driving signal has a second duty ratio that is higher than the first duty ratio and a second frequency that is lower than the first frequency, where a duty ratio is a ratio of a length of time, during which the positive voltage or the negative voltage is applied, to a total length of time during which each driving signal is transmitted.

7. The backlight unit assembly of claim 1, wherein each of the first driving signal and the second driving signal comprises a positive voltage having a positive voltage level, a negative voltage having a negative voltage level, and a ground voltage, and combinations of the voltage levels of the first driving signal and the second driving signal comprise a first section comprising a first subsection in which the first driving signal has a positive voltage level and the second driving signal has a negative voltage level, a second section comprising a second subsection in which the first driving signal has a negative voltage level and the second driving signal has a positive voltage level, a third section comprising a third subsection in which both of the first driving signal and the second driving signal have positive voltage levels, and a fourth section comprising a fourth subsection in which both of the first driving signal and the second driving signal have negative voltage levels.

8. The backlight unit assembly of claim 7, wherein the discharge/non-discharge data is data indicating whether each of the two adjacent discharge blocks is discharged in each of the first through fourth sections according to the voltage level of the driving voltage.

9. The backlight unit assembly of claim 7, wherein the discharge/non-discharge data is data indicating whether each of the two adjacent discharge blocks is discharged in each of the first through fourth sections according to the voltage level of the driving voltage, and the memory further stores basic dimming data that are combinations of the discharge/non-discharge data, wherein the basic dimming data comprises a 100/50 combination of the discharge/non-discharge data for discharging 100% of any one of the two adjacent discharge blocks, while discharging 50% of the other one of the two adjacent discharge blocks, a 100/0 combination of the discharge/non-discharge data for discharging 100% of any one of the two adjacent discharge blocks, while discharging 0% of the other one of the two adjacent discharge blocks, a 100/100 combination of the discharge/non-discharge data for discharging 100% of both of the two adjacent discharge blocks, a 50/50 combination of the discharge/non-discharge data for discharging 50% of both of the two adjacent discharge blocks, and a 0/0 combination of the discharge/non-discharge data for discharging 0% of both of the two adjacent discharge blocks.

10. The backlight unit assembly of claim 9, wherein the dimming control signals are generated by combining the basic dimming data based on a result of comparing a length of time “Ww” during which both of the two adjacent discharge blocks are discharged, a length of time “Wm” during which any one of the two adjacent discharge blocks is discharged, and a length of time “Wb” during which none of the two adjacent discharge blocks is discharged.

11. The backlight unit assembly of claim 10, wherein, when Wm is longer than a sum of Ww and Wb, the first driving signal, the second driving signal and the driving voltage are provided for 2Ww according to the 100/50 combination, for 2Wb according to the 50/0 combination, and for Wm−Ww−Wb according to the 100/0 combination.

12. The backlight unit assembly of claim 10, wherein, when Wm is shorter than the sum of Ww and Wb, when Ww is longer than Wm, and when a difference between Ww and Wm is longer than Wb, the first driving signal, the second driving signal, and the driving voltage are provided for 2Wm according to the 100/50 combination, for 2Wb according to the 50/50 combination, and for Ww−Wm−Wb according to the 100/100 combination.

13. The backlight unit assembly of claim 10, wherein, when Wm is shorter than a sum of Ww and Wb, when Ww is longer than Wm, and when a difference between Ww and Wm is shorter than Wb, the first driving signal, the second driving signal, and the driving voltage are provided for 2Wm according to the 100/50 combination, for 2(Ww−Wm) according to the 50/50 combination, and for Wb−(Ww−Wm) according to the 0/0 combination.

14. The backlight unit assembly of claim 10, wherein, when Wm is longer than Ww, the first driving signal, the second driving signal, and the driving voltage are provided for 2Ww according to the 100/50 combination, for 2(Wm−Ww) according to the 50/0 combination, and for Wb−(Wm−Ww) according to the 0/0 combination.

15. A display device comprising:
a display panel that displays an image;
a display panel driver that drives the display panel;
a surface light source that comprises a plurality of first electrode lines extending in a first direction, a plurality of second electrode lines insulated from the plurality of first electrode lines and extending in a second direction, and a plurality of discharge blocks defined in regions where the plurality of first electrode lines and the plurality of second electrode lines respectively cross each other;
a memory that stores discharge/non-discharge data indicating whether each of two adjacent ones of the plurality of discharge blocks is discharged according to each combination of voltage levels of a first driving signal, a second driving signal, and a driving voltage that are provided to a region in which the two adjacent ones of the plurality of discharge blocks are defined;
a luminance calculator that calculates luminances of a selected region based on an image signal; and
a dimming controller that outputs dimming control signals corresponding to the calculated luminances by using the discharge/non-discharge data stored in the memory,
wherein the first driving signal is transmitted to any one of the first electrode lines, the second driving signal having a different waveform from the first driving signal is transmitted to another one of the first electrode lines that is adjacent the first electrode line having the first driving signal transmitted thereto, and the driving voltage is applied to one of the second electrodes lines that crosses the that two first electrode lines having the first and second driving signals transmitted thereto, and the first and second driving signals and the driving voltage are adjusted according to the dimming control signals and provided to the surface light source.

16. The display device of claim 15, wherein the display panel comprises a plurality of display panel blocks that are disposed at locations corresponding to the plurality of discharge blocks, respectively.

17. The display device of claim 15, wherein each of the first driving signal and the second driving signal comprises a positive voltage having a positive voltage level, a negative voltage having a negative voltage level, and a ground voltage, wherein combinations of the voltage levels of the first driving signal and the second driving signal comprise a first section comprising a first subsection in which the first driving signal has a positive voltage level and the second driving signal has a negative voltage level, a second section comprising a second subsection in which the first driving signal has a negative voltage level and the second driving signal has a positive voltage level, a third section comprising a third subsection in which both of the first driving signal and the second driving signal have positive voltage levels, and a fourth section comprising a fourth subsection in which both of the first driving signal and the second driving signal have negative voltage levels, and the discharge/non-discharge data is data indicating whether each of the two adjacent ones of the plurality of discharge blocks is discharged in each of the first through fourth sections according to the voltage level of the driving voltage.

18. The display device of claim 17, wherein the memory further stores basic dimming data that are combinations of the discharge/non-discharge data, wherein the basic dimming data comprises a 100/50 combination of the discharge/non-discharge data for discharging 100% of any one of the two adjacent discharge blocks, while discharging 50% of the other one of the two adjacent discharge blocks, a 100/0 combination of the discharge/non-discharge data for discharging 100% of any one of the two adjacent discharge blocks, while discharging 0% of the other one of the two adjacent discharge blocks, a 100/100 combination of the discharge/non-discharge data for discharging 100% of both of the two adjacent discharge blocks, a 50/50 combination of the discharge/non-discharge data for discharging 50% of both of the two adjacent discharge blocks, and a 0/0 combination of the discharge/non-discharge data for discharging 0% of both of the two adjacent discharge blocks, and the dimming control signals are generated by combining the basic dimming data based on a result of comparing a length of time “Ww” during which both of the two adjacent ones of the plurality of discharge blocks are discharged, a length of time “Wm” during which any one of the two adjacent discharge blocks is discharged, and a length of time “Wb” during which none of the two adjacent discharge blocks is discharged.

19. A dimming method comprising:
providing a display device having a surface light source that comprises a plurality of first electrode lines extending in a first direction, a plurality of second electrode lines insulated from the plurality of first electrode lines and extending in a second direction, and a plurality of discharge blocks defined in regions where the plurality of first electrode lines and the plurality of second electrode lines respectively cross each other;
storing discharge/non-discharge data indicating whether each of two adjacent ones of the plurality of discharge blocks is discharged according to each combination of voltage levels of a first driving signal, a second driving signal, and a driving voltage that are provided to a region in which the two adjacent ones of the plurality of discharge blocks are defined;
calculating respective luminances of the plurality of display panel blocks based on an image signal;
outputting dimming control signals corresponding to the calculated luminances by using the discharge/non-discharge data; and
adjusting the first and second driving signals and the driving voltage according to the dimming control signals and providing the adjusted first and second driving signals and driving voltage,
wherein the first driving signal is transmitted to any one of the first electrode lines, the second driving signal having a different waveform from the first driving signal is transmitted to another one of the first electrode lines that is adjacent the first electrode line having the first driving signal transmitted thereto, and the driving voltage is applied to one of the second electrodes lines that crosses the two first electrode lines having the first and second driving signals transmitted thereto.

20. The dimming method of claim 19, further comprising storing basic dimming data, which are combinations of the discharge/non-discharge data, after the storing of the discharge/non-discharge data, wherein the basic dimming data comprises a 100/50 combination of the discharge/non-discharge data for discharging 100% of any one of the two adjacent discharge blocks, while discharging 50% of the other one of the two adjacent discharge blocks, a 100/0 combination of the discharge/non-discharge data for discharging 100% of any one of the two adjacent discharge blocks, while discharging 0% of the other one of the two adjacent discharge blocks, a 100/100 combination of the discharge/non-discharge data for discharging 100% of both of the two adjacent discharge blocks, a 50/50 combination of the discharge/non-discharge data for discharging 50% of both of the two adjacent discharge blocks, and a 0/0 combination of the discharge/non-discharge data for discharging 0% of both of the two adjacent discharge blocks, and the dimming control signals are generated by combining the basic dimming data based on a result of comparing a length of time “Ww” during which both of the two adjacent discharge blocks are discharged, a length of time “Wm” during which any one of the two adjacent discharge blocks is discharged, and a length of time “Wb” during which none of the two adjacent discharge blocks is discharged.
